(19) United States
(12) Patent Application Publication
(10) Pub. No.: US 2026/0169672 A1
(43) Pub. Date: Jun. 18, 2026

(54) INFORMATION PROCESSING DEVICE AND INFORMATION PROCESSING METHOD FOR PRESENTING VIRTUAL CONTENT TO A USER

(71) Applicant: Sony Semiconductor Solutions Corporation, Kanagawa (JP)

(72) Inventors: Yuki TSUJI, Kanagawa (JP); Sayuri WAKABAYASHI, Kanagawa (JP)

(73) Assignee: Sony Semiconductor Solutions Corporation, Kanagawa (JP)

(21) Appl. No.: 19/128,743

(22) PCT Filed: Nov. 9, 2023
(86) PCT No.: PCT/JP2023/040477

§ 371 Date: May 9, 2025

(30) Foreign Application Priority Data
Nov. 17, 2022 (JP) 2022-184080

(51) Int. Cl. G06F 3/14

(52) U.S. Cl. CPC G06F 3/1454

(57) ABSTRACT

An information processing device can include a control unit capable of communicating with each of a terminal device including a presentation unit that presents virtual content to a user and a first camera, and an imaging device including a second camera disposed in a same space as the terminal device. The control unit can acquire, from the imaging device, user information including an attribute of the user estimated by the imaging device based on a captured image by the second camera and locus information indicating movement of the user over time, associate the user information with the terminal device by collating the locus information of the user by the imaging device with locus information of the user indicated by the terminal device, and cause the terminal device to set (e.g., change) a mode of the virtual content presented by the terminal device to the presentation unit depending on the user information.

### CROSS-REFERENCE TO RELATED APPLICATION

The present application claims priority to Japanese Patent Application No. JP 2022-184080, filed Nov. 17, 2022, wherein the entire content and disclosure of the foregoing application is incorporated by reference herein in its entirety.

### TECHNICAL FIELD

The present disclosure relates to an information processing device and an information processing method.

### BACKGROUND ART

In the related art, extended reality (XR) or cross reality, which is image processing technology for fusing a virtual space and a real space, such as virtual reality (VR) and augmented reality (AR), is known.

The XR content using the XR is provided to a user via an XR terminal such as a smartphone carried by the user or a head mounted display (HMD) that the user wears on the head.

The XR terminals include a display and a camera and display a virtual object corresponding to a real object existing in the real space or a virtual object of an object not existing in the real space in an XR space viewed through the camera or having been subjected to image processing.

Note that, in providing such XR content, for a virtual object corresponding to a real object, technology of improving the quality by suppressing disturbance in the display depending on the stability of recognition of the position and the orientation of the real object in a camera image has been proposed (see, for example, Patent Literature 1).

### CITATION LIST

### Patent Literature

PTL 1: Japanese Laid-open Patent Publication No. 2012-221250 A

### SUMMARY

### Technical Problem

However, the above-described related art has room for further improvement in providing appropriate XR content depending on each user.

For example, in other words, the above-described related art switches the display of the virtual object depending on the position and the orientation of the real object in the camera image. However, in the XR content, it is desirable to appropriately switch the display of the virtual object also depending on, for example, the position and the orientation of the XR terminal.

Then, the position and the orientation of the XR terminal are easily affected by characteristics of each user such as the height or the behavior of the user who uses the XR terminal. In this regard, the above-described related art is merely intended to accurately recognize the position and the orientation of the real object in the camera image and does not further recognize characteristics of each user.

Therefore, the present disclosure proposes an information processing device and an information processing method capable of providing appropriate XR content depending on each user.

### Solution to Problem

In order to solve the above problems, one aspect of an information processing device according to the present disclosure can include a control unit capable of communicating with a terminal device that can include a presentation unit to present virtual content to a user and a first camera, and an imaging device including a second camera in a same space as the terminal device. The control unit can acquire, from the imaging device, user information including an attribute of the user estimated by the imaging device based on a captured image captured by the second camera and locus information indicating movement of the user over time, associates the user information with the terminal device by collating the locus information of the user from the imaging device with locus information of the user indicated from the terminal device, and causes the terminal device to set (e.g., change) a mode of the virtual content presented by the terminal device to the presentation unit depending on the user information. The control unit may be implemented in or using control circuitry.

### BRIEF DESCRIPTION OF DRAWINGS

FIG. 1 is a schematic explanatory diagram (#1) of an information processing method according to an embodiment of the present disclosure.

FIG. 2 is a schematic explanatory diagram (#2) of the information processing method according to the embodiment of the present disclosure.

FIG. 3 is a schematic explanatory diagram (#3) of the information processing method according to the embodiment of the present disclosure.

FIG. 4 is a diagram illustrating a configuration example of an information processing system according to the embodiment of the present disclosure.

FIG. 5 is a block diagram illustrating a configuration example of an XR terminal according to the embodiment of the present disclosure.

FIG. 6 is a block diagram illustrating a configuration example of a facility camera according to the embodiment of the present disclosure.

FIG. 7 is a block diagram illustrating a configuration example of a server device according to the embodiment of the present disclosure.

FIG. 8 is a diagram illustrating a processing sequence executed by the information processing system according to the embodiment of the present disclosure.

FIG. 9 is a conceptual diagram of an information processing system according to a modification.

FIG. 10 is a diagram illustrating a processing sequence executed by the information processing system according to the modification.

FIG. 11 is a hardware configuration diagram illustrating an example of a computer that implements the functions of the server device.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

Meanwhile, in the present specification and the drawings, a plurality of components having substantially the same or similar functional configurations may be distinguished by attaching different numbers after the same symbol in the manner of “-n” (n is a natural number). However, in a case where it is not particularly necessary to distinguish each of the plurality of components having substantially the same or similar functional configurations, only the same symbol is attached.

In addition, hereinafter, the “XR space” is a generic term for various spaces in the image processing technology that fuses a virtual space and a real space, such as a virtual reality space in VR, an augmented reality space in AR, a mixed reality space in mixed reality (MR), and a substitutional reality space in substitutional reality (SR).

Furthermore, the “XR content” refers to content that presents, to an XR space, various virtual objects each corresponding to a real object existing in a real space or an object not existing in the real space and provides a user with a simulated experience in the XR space.

Furthermore, in the following, an example will be described in which an information processing system 1 according to an embodiment of the present disclosure (hereinafter, referred to as “the embodiment” as appropriate) provides XR content to an XR terminal used by a user in various facilities such as museums.

The present disclosure will be described in the following order of items.
1. Overview
2. Configuration of Information Processing System
3. Configuration of XR Terminal
4. Configuration of Facility Camera
5. Configuration of Server Device
6. Processing Procedure
7. Modifications
8. Hardware Configuration
9. Conclusion

### 1. Overview

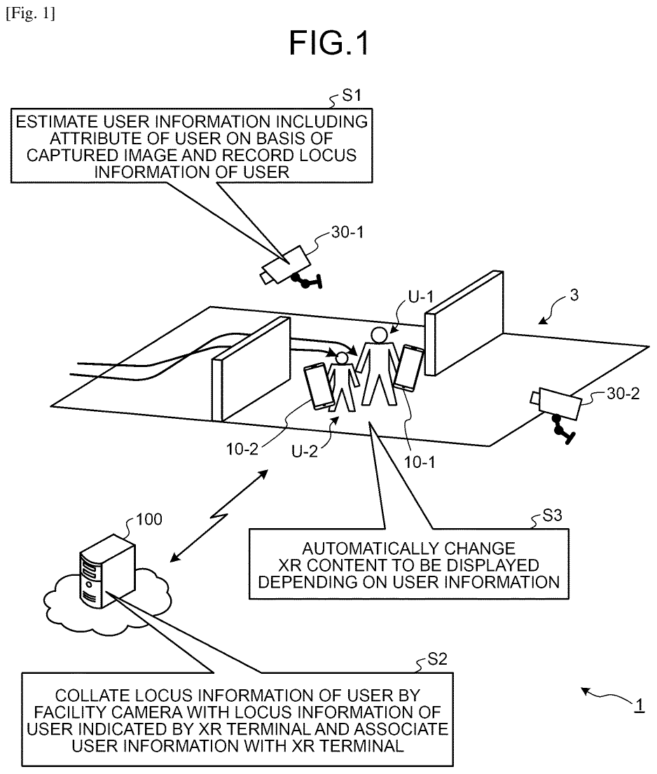

FIGS. 1 to 3 are schematic explanatory diagrams of an information processing method according to an embodiment of the present disclosure (#1 to #3). As illustrated in FIG. 1, the information processing system 1 according to the embodiment includes XR terminals 10, facility cameras 30, and a server device 100.

An XR terminal 10 is a terminal device that executes application software (hereinafter, referred to as “the XR application”) for a user U to enjoy XR content. The XR terminals 10 correspond to an example of a “terminal device”. The XR terminal 10 is implemented by, for example, a tablet terminal, a personal computer (PC), a personal digital assistant (PDA), or the like, in addition to a smartphone or an HMD. In a case where the XR terminal 10 is an HMD, this may be a headband-type HMD using a band that goes around the entire circumference of the temporal part or a band that passes through the top of the head, a helmet-type HMD in which a visor portion serves as a display, a glasses-type HMD in which the lens portion serves as a display, or the like.

Note that FIG. 1 illustrates an example in which the XR terminal 10 is a smartphone, a user U-1 uses an XR terminal 10-1, and a user U-2 uses an XR terminal 10-2. Furthermore, it is based on a premise that the user U-1 and the user U-2 are, for example, a parent and a child and that the user U-1 is taller than the user U-2.

One or more facility cameras 30 are provided in the XR facility 3. The facility cameras 30 correspond to an example of an “imaging device”. The XR facility 3 has a real space in which XR content can be provided to the users U. The XR facility 3 may be a facility in which the users U can enjoy the XR content while traveling in an indoor space, such as museums or may be a facility in which the users U can enjoy the XR content while traveling in an outdoor space, such as an amusement park or a street.

The facility cameras 30 are intelligent cameras (also referred to as smart cameras) mounted with a processor such as a central processing unit (CPU). The facility cameras 30 are capable of executing various types of information processing such as detection processing of a user U based on a captured image, estimation processing of the attribute of the detected user U, and tracking processing of the detected user U. Note that illustrated in FIG. 1 is an example in which at least two facility cameras 30-1 and 30-2 are provided in the XR facility 3.

The server device 100 is a computer that is capable of communicating with various devices in the XR facility 3 including the XR terminals 10 and the facility cameras 30 and manages and controls these various devices. The server device 100 may be provided inside or outside the XR facility 3. Furthermore, the server device 100 may be implemented as a public cloud server including one or more computers. Note that the following description is based on a premise that information processing executed by the server device 100 is virtually performed by one server device 100, however, the number of physical server devices 100 is not limited thereto. For example, in a case where the server device 100 is implemented as a public cloud server, the information processing executed by the server device 100 may be actually executed in a distributed manner by one or more computers as appropriate.

The server device 100 associates a user U with an XR terminal 10 on the basis of, for example, various pieces of information acquired from the XR terminal 10 and the facility cameras 30. Furthermore, the server device 100 causes the XR terminal 10 to present appropriate XR content depending on each user U on the basis of the association result.

Specifically, in the information processing method according to the embodiment, the server device 100 acquires user information including the attribute of a user U estimated by a facility camera 30 on the basis of a captured image by the facility camera 30 and locus information indicating the locus of the user U from facility cameras 30, associates the user information with an XR terminal 10 by collating the locus information of the user U by the facility camera 30 with locus information of the user U indicated by the XR terminal 10, and causes the XR terminal 10 to change the mode of the XR content presented by the XR terminal 10 depending on the user information.

More specifically, as illustrated in FIG. 1, in the information processing method according to the embodiment, first, the facility camera 30 estimates the user information including the attribute of the user U on the basis of the captured image by the facility camera 30 and records the locus information of the user U (step S1).

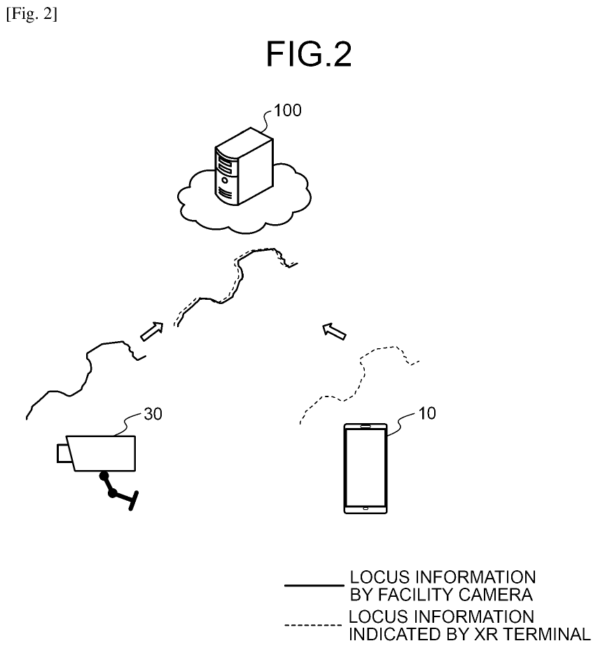

The attribute of the user U includes, for example, a demographic attribute such as the age or the gender in addition to an external attribute such as the height of the user U. The locus information of the user U can indicate a locus of each user U, for instance, in the XR facility 3. The term “locus,” as used herein when referring to the user U, can be regarded as a set of points associated with spatial movement of the user U within a same space as the facility camera(s) 30 and the XR terminal 10. Thus, in the case of the facility camera(s) 30, locus information can be regarded as a series of position /d/ or orientation data of the user U associated with spatial movement of the user U within the space, as captured by the facility camera(s) 30. And in the case of the XR terminal 10, locus information can be regarded as a series of position and/or orientation data associated with spatial movement of the user U, for instance, within the space, as captured by the XR terminal 10. The solid curved line in FIG. 2 shows an example of locus information associated with spatial movement of the user U, as captured by the facility camera(s) 30. The broken line curved line in FIG. 2 shows an example of locus information associated with spatial movement of the user U, as captured by the XR terminal 10. Optionally, locus information for multiple users U can be captured and implemented.

Then, the server device 100 collates the locus information of the user U by the facility cameras 30 with the locus information of the user U indicated by the XR terminal 10 and associates the user information estimated by the facility camera 30 with the XR terminal 10 (step S2).

In step S2, as illustrated in FIG. 2, the server device 100 collates the locus information of the user U by the facility cameras 30 with the locus information indicated by the XR terminal 10 and associates those having similar loci in the XR facility 3 as the same user. The locus information indicated by XR terminal 10 is, for example, a log of user position information including the position and the orientation of the XR terminal 10 estimated using visual positioning service (VPS).

Note that the locus information indicated by the XR terminal 10 may not use the VPS but may be a log of position information of the global positioning system (GPS) acquired from the XR terminal 10 and/or may be a log of position information of the XR terminal 10 using one or more beacon terminals provided in the XR facility 3. It is based on a premise that the VPS is used in the embodiment.

Let us return to the description of FIG. 1. Then, the server device 100 transmits the user information associated in step S2 to each of the XR terminals 10 and causes the XR content to be displayed to be automatically changed depending on the user information (step S3).

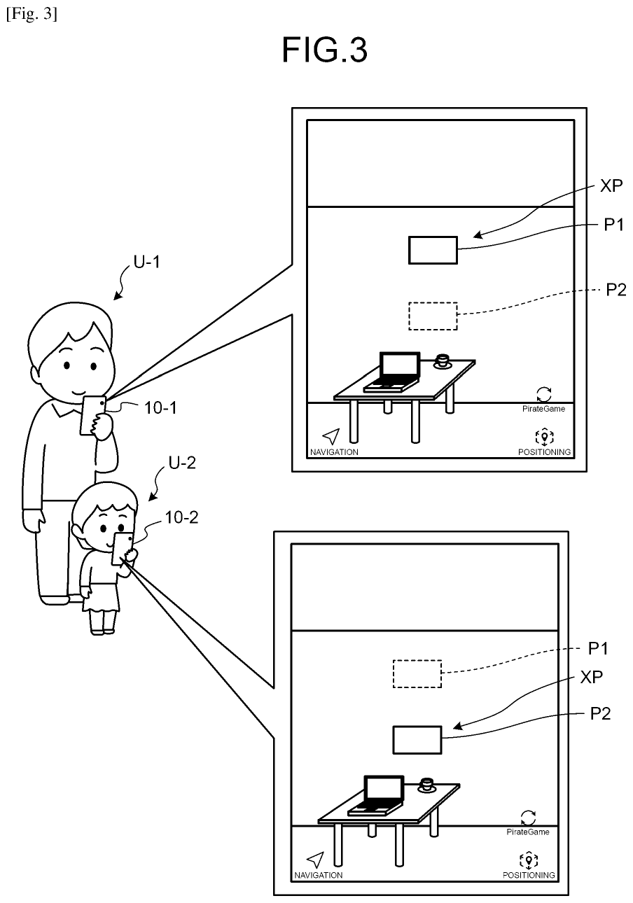

In step S3, as illustrated in FIG. 3, for example, the server device 100 causes the XR terminal 10-1 of user U-1 who is taller than user U-2 to display a virtual poster XP displayed at a specific location in the same XR content at a position P1 that is higher than a position P2.

Meanwhile, the server device 100 causes the XR terminal 10-2 of the user U-2 who is shorter than the user U-1 to display the same poster XP at the position P2 that is lower than the position P1. That is, the server device 100 switches the display of the virtual object such that the poster XP is displayed at a height corresponding to the height of each user U even for the same XR content.

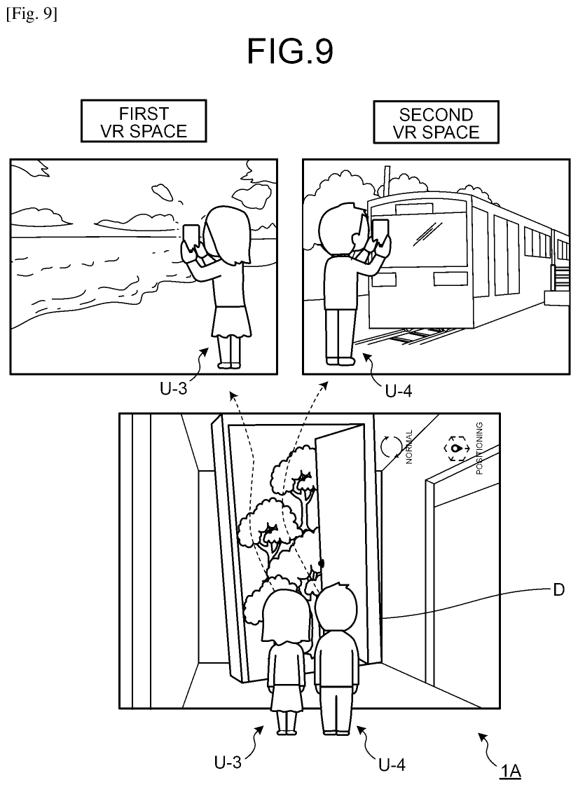

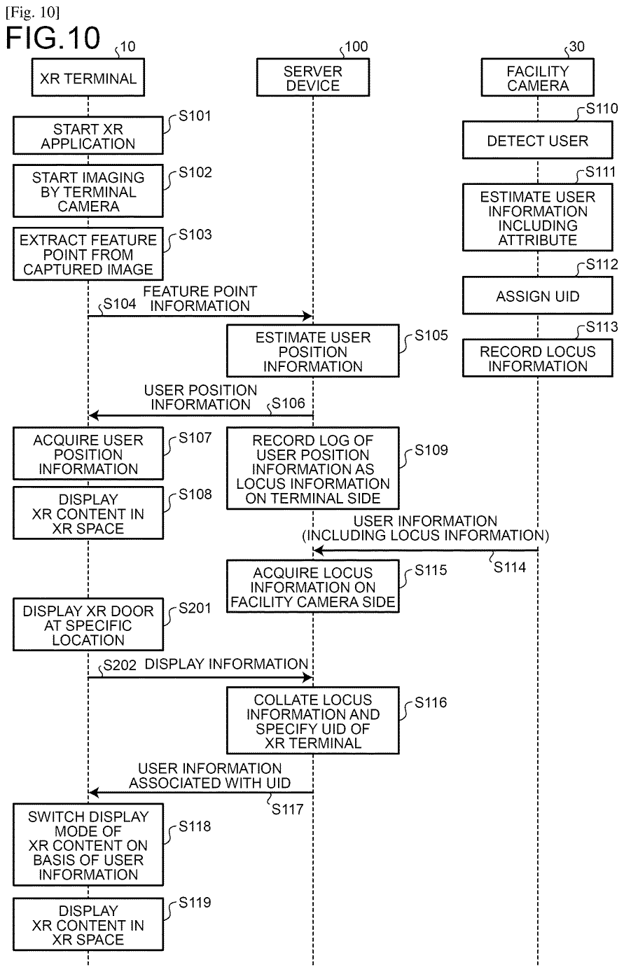

Note that, at this point, the display of the virtual object may be switched including the content depending on the age of the user U so that not only the position of the poster XP but also that the poster XP for adults is displayed for the user U-1 while the poster XP for children is displayed for the user U-2. A modification in which the switching is performed depending on the demographic attribute of the user U such as the age or the gender will be described later with reference to FIGS. 9 and 10.

As described above, in the information processing method according to the embodiment, the server device 100 acquires user information including the attribute of a user U estimated by a facility camera 30 on the basis of a captured image by the facility camera 30 and locus information indicating the locus of the user U from facility cameras 30, associates the user information with an XR terminal 10 by collating the locus information of the user U by the facility cameras 30 with the locus information of the user U indicated by the XR terminal 10, and causes the XR terminal 10 to change the mode of the XR content presented by the XR terminal 10 depending on the user information.

Therefore, according to the information processing method according to the embodiment, it is possible to provide appropriate XR content depending on each user U. Hereinafter, a configuration example of the information processing system 1 applied with the information processing method according to the embodiment will be described more specifically.

### 2. Configuration of Information Processing System

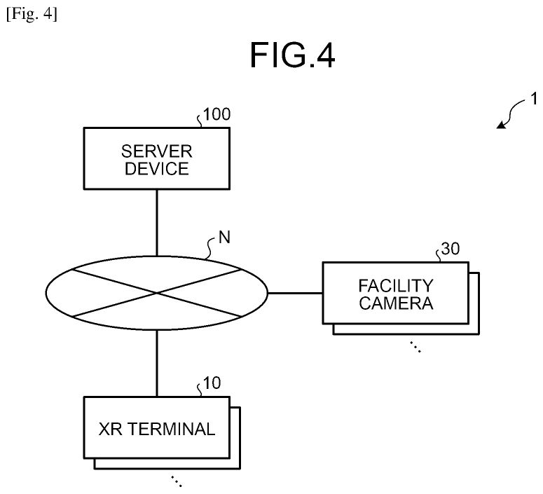

Next, FIG. 4 is a diagram illustrating a configuration example of the information processing system 1 according to the embodiment of the present disclosure. Note that in the description using FIG. 4 and FIG. 5 to 7 described later, description of components that are already described may be simplified or omitted.

As illustrated in FIG. 4, the information processing system 1 includes one or more XR terminals 10, one or more facility cameras 30, and the server device 100.

As described above, an XR terminal 10 is a terminal device used by a user U. In the XR terminal 10, one or more XR applications are installed. When a user U selects an XR application that is desired to be executed, the XR terminal 10 starts and executes the application.

The XR terminals 10, the facility cameras 30, and the server device 100 are communicably connected to each other via a network N which is the Internet, a mobile phone line network, or the like. Note that at least the XR terminals 10 and the server device 100 may be capable of communicating with each other only in a case where authentication has been completed through predetermined authentication processing.

### 3. Configuration of XR Terminal

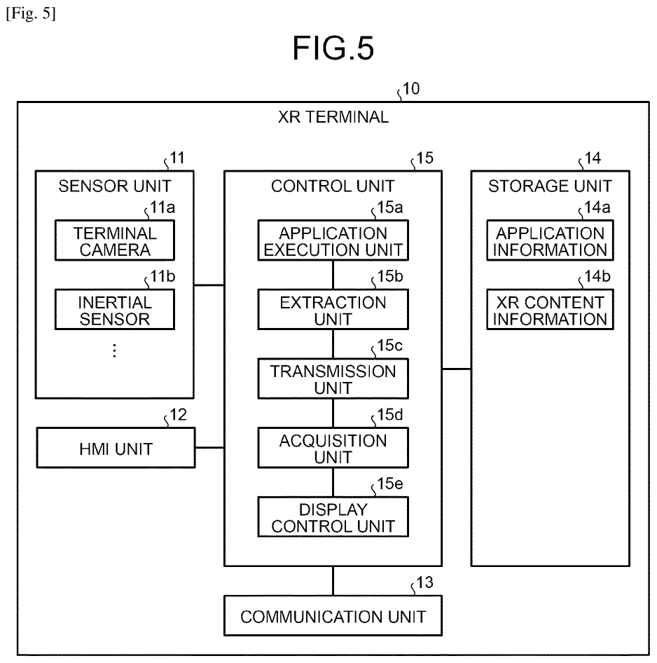

Next, FIG. 5 is a block diagram illustrating a configuration example of an XR terminal 10 according to the embodiment of the present disclosure. Note that, in FIG. 5 and FIGS. 6 and 7 illustrated later, only components necessary for describing the features of the embodiment are illustrated, and description of general components are omitted.

In other words, each component illustrated in FIGS. 5 to 7 is conceptual in terms of function and is not necessarily physically configured as illustrated in the drawings. For example, the specific form of distribution or integration of each block is not limited to those illustrated in the drawings, and the whole or a part thereof can be functionally or physically distributed or integrated in any unit depending on various loads, usage status, and others.

As illustrated in FIG. 5, the XR terminal 10 includes a sensor unit 11, a human machine interface (HMI) unit 12, a communication unit 13, a storage unit 14, and a control unit 15.

The sensor unit 11 is a sensor group that acquires various types of sensor information regarding the surrounding situation of the XR terminal 10 and the state of the XR terminal 10. The sensor unit 11 includes a terminal camera 11a and an inertial sensor 11b.

The terminal camera 11a captures an image of a subject (namely, a real space and a real object existing in the real space) positioned in front of the user U. The terminal camera 11a corresponds to an example of a “first camera”.

The inertial sensor 11b has a function as an inertial measurement unit (IMU) that measures the acceleration and the angular velocity of the XR terminal 10. The inertial sensor 11b includes an acceleration sensor and an angular velocity sensor (not illustrated) and measures the acceleration and the angular velocity of the XR terminal 10.

The HMI unit 12 is a component that provides an interface component related to input and output to the user U. The HMI unit 12 corresponds to an example of a “presentation unit”. The HMI unit 12 includes an input interface that receives an input operation from the user U. The input interface is implemented by, for example, a touch panel. Note that the input interface may be implemented by a keyboard, a mouse, a pen tablet, a microphone, or the like. In addition, the input interface may be implemented by a software component.

In addition, the HMI unit 12 includes an output interface that presents image information or audio information to the user U. The output interface is implemented by, for example, a display, a speaker, or the like. Note that the HMI unit 12 may be implemented by a touch panel display in which the input interface and the output interface are integrated.

The communication unit 13 is implemented by a network adapter or the like. The communication unit 13 is wirelessly connected with the server device 100 via the network N and transmits and receives various types of information to and from the server device 100.

The storage unit 14 is implemented by, for example, a storage device such as a random access memory (RAM), a read only memory (ROM), or a flash memory. In the example of FIG. 5, the storage unit 14 stores application information 14a and XR content information 14b.

The application information 14a is information including programs of one or more XR applications, programs of applications other than the XR applications, programs according to the embodiment executed by the XR terminal 10, various parameters used during execution of these programs, and others.

The XR content information 14b can be regarded as information in which a virtual object group to be displayed in the XR space is set depending on user position information acquired from the server device 100. In addition, the XR content information 14b can be regarded as information in which a display mode of a virtual object is set for each display mode of XR content that is set (e.g., switched) depending on user information of the user U that is acquired from the server device 100. Thus, mode of the presented content can be regarded as a display mode of the presented content (e.g., the virtual object), according to one or more embodiments of the present disclosure. More generally, however, mode of the presented content can be regarded as a characteristic of the content, as presented. Thus, setting (e.g., changing or switching) a mode of the presented content can be regarded as setting one or more presentation characteristics of the content. As examples, such characteristics can include size, location (e.g., height, space, etc.), substance of the content itself, artistic nature of the content (e.g., color, font, etc.).

The control unit 15 corresponds to a so-called controller or processor. The control unit 15 is implemented by, for example, a central processing unit (CPU), a micro processing unit (MPU), a graphics processing unit (GPU), or the like executing various programs stored in the storage unit 14 using the RAM as a work area. Furthermore, the control unit 15 can be implemented by, for example, an integrated circuit such as an application specific integrated circuit (ASIC) or a field programmable gate array (FPGA).

The control unit 15 includes an application execution unit 15a, an extraction unit 15b, a transmission unit 15c, an acquisition unit 15d, and a display control unit 15e and implements or executes a function or an action of information processing described below.

The application execution unit 15a reads an XR application selected by the user U via the HMI unit 12 from the application information 14a and executes the XR application.

The extraction unit 15b acquires a captured image captured by the terminal camera 11a during execution of the XR application. Furthermore, the extraction unit 15b extracts feature points in the captured image that has been acquired.

The transmission unit 15c transmits the feature point group extracted by the extraction unit 15b as feature point information to the server device 100 via the communication unit 13.

The acquisition unit 15d acquires user position information including the position and the orientation of the XR terminal 10 estimated by the server device 100 on the basis of the feature point information from the server device 100 via the communication unit 13. In addition, the acquisition unit 15d acquires, from the server device 100 via the communication unit 13, user information specified by the server device 100 collating locus information by facility cameras 30 with locus information indicated by the XR terminal 10.

The display control unit 15e displays the XR content including a virtual object depending on the user position information in the XR space on the basis of the user position information acquired by the acquisition unit 15d. The display control unit 15e further sets the display mode of the XR content in the XR content information 14b on the basis of the user information acquired by the acquisition unit 15d. In addition, the display control unit 15e displays the XR content in the XR space in a display mode corresponding to the set display mode.

### 4. Configuration of Facility Camera

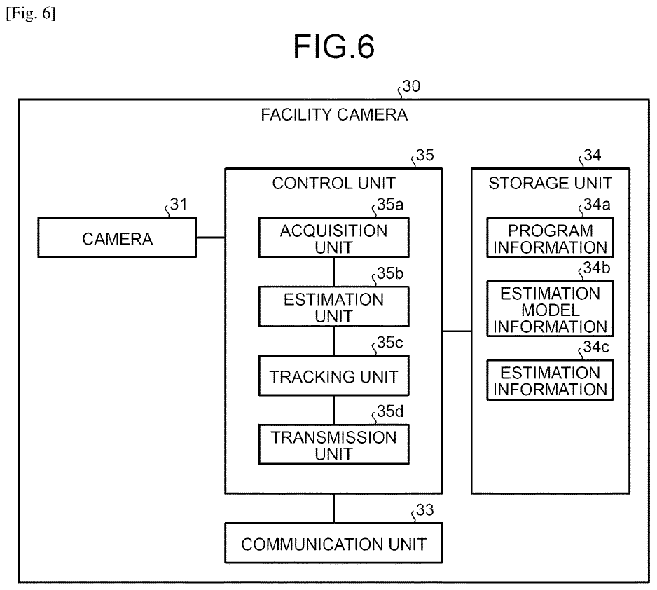

Next, a configuration example of a facility camera 30 will be described. FIG. 6 is a block diagram illustrating a configuration example of a facility camera 30 according to the embodiment of the present disclosure. As illustrated in FIG. 6, the facility camera 30 includes a camera 31, a communication unit 33, a storage unit 34, and a control unit 35.

The camera 31 is capable of capturing an image of a predetermined imaging region in the XR facility 3. The camera 31 corresponds to an example of a “second camera” disposed in the same space as the first camera (the terminal camera 11a). The term “same space,” as used herein, can be regarded as an area or volume that physically contains at least the first camera (e.g., terminal camera 11a) and the second camera or cameras (e.g., camera 30, camera 30-1, and/or camera 30-2, etc.) FIG. 1 shows an example of a same space according to one or more embodiments of the disclosed subject matter. In particular, FIG. 1 shows that the same space can be regarded as an XR facility (e.g., building, specific room, etc.).

The communication unit 33 is implemented by a network adapter or the like. The communication unit 33 is connected with the server device 100 via the network N in a wired or wireless manner and transmits and receives various types of information to and from the server device 100.

The storage unit 34 is implemented by a storage device such as a RAM, a ROM, or a flash memory. In the example of FIG. 6, the storage unit 34 stores program information 34a, estimation model information 34b, and estimation information 34c.

The program information 34a is information including the program according to the embodiment executed by the facility cameras 30, various parameters used during the execution of the program, and others.

The estimation model information 34b is information including an estimation model used in estimation processing of the attribute of the user U based on the captured image of the camera 31 executed by an estimation unit 35b described later. This estimation model is, for example, a deep neural network (DNN) model generated using a deep learning algorithm.

The estimation information 34c stores user information for each user U including the attribute estimated by the estimation unit 35b. A user ID (hereinafter referred to as “UID”), which is an identifier for uniquely identifying a user U, is assigned to each piece of user information.

In addition, in the estimation information 34c, locus information (see FIG. 2) by the facility cameras 30 is stored for each UID. The locus information is recorded by tracking processing executed by a tracking unit 35c described later.

The control unit 35 corresponds to a so-called controller or processor. The control unit 35 is implemented by, for example, a CPU, an MPU, a GPU, or the like executing various programs stored in the storage unit 34 using the RAM as a work area. Alternatively, the control unit 35 can be implemented by an integrated circuit such as an ASIC or an FPGA.

The control unit 35 includes an acquisition unit 35a, the estimation unit 35b, the tracking unit 35c, and a transmission unit 35d and implements or executes a function or an action of information processing described below.

The acquisition unit 35a acquires a captured image by the camera 31 from the camera 31. The estimation unit 35b detects each user U who uses the XR facility 3 on the basis of the captured image acquired by the acquisition unit 35a while using the estimation model information 34b and estimates user information including the attribute of each user U who has been detected.

Furthermore, the estimation unit 35b stores the estimated user information in the estimation information 34c. At this point, the estimation unit 35b assigns a UID to each piece of user information.

The tracking unit 35c executes tracking processing of tracking each user U detected by the estimation unit 35b on the basis of the captured image by the camera 31. In addition, the tracking unit 35c records the locus information by the facility cameras 30 described above in the estimation information 34c for each UID on the basis of the result of the tracking processing.

The transmission unit 35d transmits the user information and the locus information of each user U who is using the XR facility 3 recorded in the estimation information 34c to the server device 100 via the communication unit 33.

### 5. Configuration of Server Device

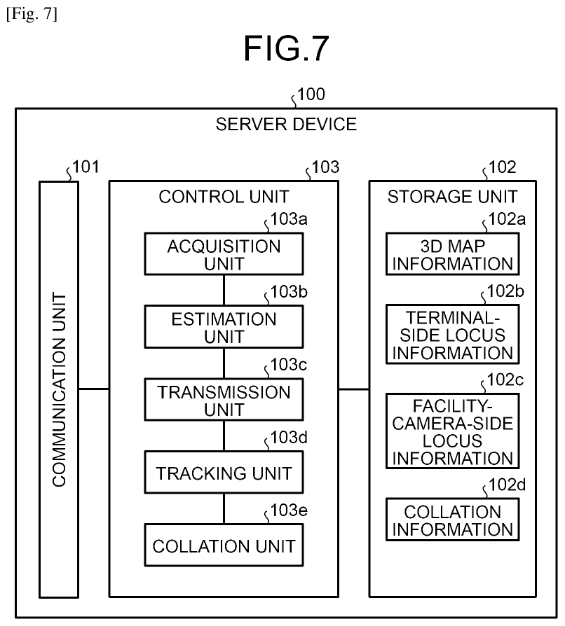

Next, a configuration example of the server device 100 will be described. FIG. 7 is a block diagram illustrating a configuration example of the server device 100 according to the embodiment of the present disclosure. As illustrated in FIG. 7, the server device 100 includes a communication unit 101, a storage unit 102, and a control unit 103.

The communication unit 101 is implemented by a network adapter or the like. The communication unit 101 is connected with the XR terminals 10 and the facility cameras 30 via the network N in a wired or wireless manner and transmits and receives various types of information to and from the XR terminals 10 and the facility cameras 30.

The storage unit 102 is implemented by a storage device such as a RAM, a ROM, a flash memory, or a hard disk device. In the example of FIG. 7, the storage unit 102 stores three-dimensional (3D) map information 102a, terminal-side locus information 102b, facility-camera-side locus information 102c, and collation information 102d.

The 3D map information 102 a is information including a 3D map of the XR facility 3. The terminal-side locus information 102b stores the locus information (see FIG. 2) indicated by the XR terminal 10 described above. The locus information is recorded by tracking processing executed by a tracking unit 103d described later.

The facility-camera-side locus information 102c stores the locus information (see FIG. 2) by the facility cameras 30 transmitted from the facility camera 30. The locus information is recorded by an acquisition unit 103a described later.

The collation information 102d stores a collation result of collation processing of terminal-side locus information 102b and facility-camera-side locus information 102c executed by a collation unit 103e described later. The collation result includes a UID specified as that corresponding to the XR terminal 10 and user information associated with the UID.

Furthermore, although not illustrated, the storage unit 102 stores a program according to the embodiment executed by the server device 100.

The control unit 103 corresponds to a so-called controller or processor. The control unit 103 is implemented by, for example, a CPU, an MPU, a GPU, or the like executing various programs stored in the storage unit 102 using the RAM as a work area. Alternatively, the control unit 103 can be implemented by an integrated circuit such as an ASIC or an FPGA.

The control unit 103 includes the acquisition unit 103a, an estimation unit 103b, a transmission unit 103c, the tracking unit 103d, and the collation unit 103e and implements or executes a function or an action of information processing described below.

The acquisition unit 103a acquires the feature point information transmitted from the XR terminal 10 via the communication unit 101. Furthermore, the acquisition unit 103a acquires the user information and the locus information of each user U who is using the XR facility 3 that are transmitted from the facility cameras 30 via the communication unit 101. In addition, the acquisition unit 103a records the locus information of the facility cameras 30 side acquired from the facility cameras 30 in the facility-camera-side locus information 102c.

The estimation unit 103b estimates the above-described user position information including the position and the orientation of the XR terminal 10 in the XR facility 3 using the VPS on the basis of the feature point information and the 3D map information 102a from the XR terminal 10 acquired by the acquisition unit 103a. Furthermore, the estimation unit 103b causes the transmission unit 103c to transmit the estimated user position information to the XR terminal 10.

The transmission unit 103c transmits the user position information estimated by the estimation unit 103b to the XR terminal 10 via the communication unit 101. Furthermore, the transmission unit 103c transmits, to the XR terminal 10 via the communication unit 101, user information associated with the UID specified by the collation processing executed by the collation unit 103e described later.

The tracking unit 103d tracks the user position information estimated by the estimation unit 103b and records a log of the user position information that is the tracking result in the terminal-side locus information 102b as locus information on the XR terminal 10 side.

The collation unit 103e executes collation processing (see FIG. 2) of the terminal-side locus information 102b and the facility-camera-side locus information 102c and specifies the UID corresponding to the XR terminal 10, thereby associating the XR terminal 10 with the user information estimated by the facility camera 30. Furthermore, the collation unit 103e causes the transmission unit 103c to transmit user information associated with the specified UID to the XR terminal 10.

### 6. Processing Procedure

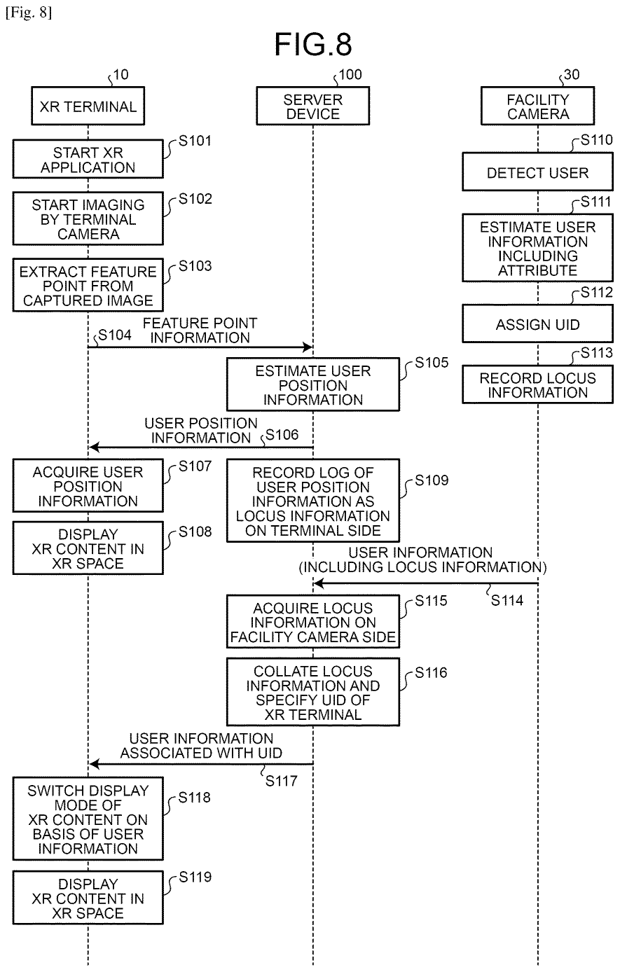

Next, a processing procedure executed by the information processing system 1 will be described with reference to FIG. 8. FIG. 8 is a diagram illustrating a processing sequence executed by the information processing system 1 according to the embodiment of the present disclosure.

As illustrated in FIG. 8, first, when an XR application is started in an XR terminal 10 (step S101), the terminal camera 11a of the XR terminal 10 starts imaging (step S102). Then, the XR terminal 10 extracts feature points from a captured image by the terminal camera 11a (step S103) and transmits feature point information, which is the extracted feature point group, to the server device 100 (step S104).

The server device 100 estimates the user position information including the position and the orientation of the XR terminal 10 on the basis of the feature point information transmitted from the XR terminal 10 (step S105). Then, the server device 100 transmits the estimated user position information to the XR terminal 10 (step S106).

When acquiring the user position information transmitted from the server device 100 (step S107), the XR terminal 10 displays the XR content including a virtual object depending on the user position information in the XR space (step S108).

Note that the server device 100 records the log of the user position information as the terminal-side locus information while repeating steps S104 to S106 (step S109).

Meanwhile, when detecting a user U who is using the XR facility 3 on the basis of the captured image (step S110), a facility camera 30 estimates user information including the attribute of the user U who has been detected (step S111). Then, the facility camera 30 assigns a UID to each piece of user information (step S112).

Furthermore, the facility camera 30 tracks the detected user U and records locus information in association with the UID (step S113). Then, the facility camera 30 transmits the user information including the locus information to the server device 100 (step S114).

When acquiring the locus information on the facility camera side transmitted from the facility camera 30 (step S115), the server device 100 specifies the UID of the XR terminal 10 by collating the locus information on the terminal side and the facility camera side (step S116).

Then, the server device 100 transmits the user information associated with the specified UID to the XR terminal 10 (step S117).

The XR terminal 10 switches the display mode of the XR content on the basis of the user information transmitted from the server device 100 (step S118). Then, the XR terminal 10 displays the XR content in the XR space depending on a display mode that has been switched to (step S119).

### 7. Modifications

Meanwhile, the embodiment of the present disclosure described above can have several modifications.

In the embodiment described above, as an example, the example has been described in which the height at which the poster XP is automatically displayed is switched depending on the height of the user U. However, as a modification, the display of the XR content may be automatically switched depending on an attribute such as the age or the gender of the user U.

FIG. 9 is a conceptual diagram of an information processing system 1A according to a modification. As illustrated in FIG. 9, for example, in a case where a user U arrives at a specific location in an XR space, the information processing system 1A displays an XR door D, which is a virtual door, in the XR space.

Here, it is based on a premise that a user U-3 and a user U-4 use XR content provided by the information processing system 1A. It is also based on another premise that the user U-3 is a female and the user U-4 is a male.

Then, for example, when a user U-3 passes through the XR door D in the XR space, the information processing system 1A causes an XR terminal 10 of the user U-3 to automatically display a first VR space depending on the gender of the user U-3. Furthermore, for example, when a user U-4 passes through the XR door D in the XR space, the information processing system 1A causes an XR terminal 10 of the user U-4 to automatically display a second VR space different from the first VR space depending on the gender of the user U-4.

Note that, herein, the example has been described in which the display of the XR content is switched depending on the gender of the user U, however, the display may be switched depending on the gender of the user U. In addition, without being limited to the demographic attribute such as the age and the gender, the display may be switched depending on, for example, a psychographic attribute such as a lifestyle or preferences.

This can be implemented by learning of the estimation model for estimating attributes of a user U in such a manner that psychographic attributes can be estimated from, for example, the clothes, the hairstyle, belongings, and the like of the user U in a captured image by the camera 31.

Note that a processing procedure executed by the information processing system 1A will also be described. FIG. 10 is a diagram illustrating a processing sequence executed by the information processing system 1A according to the modification. Since FIG. 10 corresponds to FIG. 8 that has been already illustrated, only differences from FIG. 8 will be described herein.

As illustrated in FIG. 10, in the information processing system 1A, after the XR terminal 10 displays the XR content in the XR space on the basis of the user position information from the server device 100 in step S108, the XR terminal 10 displays the XR door D at a specific location where the user U has arrived (step S201).

Then, the XR terminal 10 transmits display information indicating that the XR door D has been displayed to the server device 100 (step S202). Then, with the acquisition of the display information from the XR terminal 10 as a trigger, the server device 100 executes processing of collating the locus information of the terminal side and the facility camera side also illustrated in FIG. 8 to specify the UID of the XR terminal 10 (step S116). Thereafter, steps S117 to S119 are executed like in FIG. 8.

Furthermore, in the embodiment described above, the example of switching the display mode of the XR content has been mainly described, however, the switching target is not limited to the display mode. For example, in a case where the XR content involves presentation of audio information, tactile information, or others, the mode of audio output or tactile output may be automatically switched depending on the user information of each user U, that is, the information processing method according to the embodiment may automatically switch the mode of presentation of the XR content depending on the user information including the attribute of the user U.

Among the processing described in the above embodiments, all or a part of the processing described as that performed automatically can be performed manually, or all or a part of the processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information that has been illustrated.

In addition, each component of each device illustrated in the drawings is conceptual in terms of function and does not need to be necessarily physically configured as illustrated in the drawings. That is, the specific form of distribution and integration of devices is not limited to those illustrated in the drawings, and all or a part thereof can be functionally or physically distributed or integrated in any unit depending on various loads, use status, or the like.

For example, in the embodiment described above, the example in which the storage unit 14 of the XR terminal 10 stores the XR content information 14b has been described, however, the XR content information 14b may be stored in the storage unit 102 of the server device 100. In this case, the XR terminal 10 functions as an edge device that switches the mode of presentation of the XR content exclusively on the basis of an instruction from the server device 100. That is, in this case, the determination to cause the XR terminal 10 to switch (change) the mode of presentation of the XR content depending on the user information including the attribute of the user U is completed on the server device 100 side.

In addition, the above embodiments can be combined as appropriate as long as the processing content does not contradict each other.

### 8. Hardware Configuration

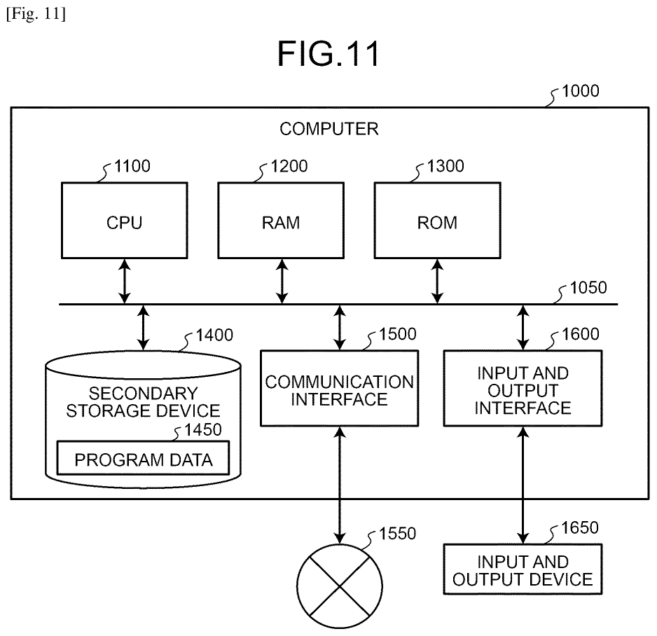

The XR terminals 10, the facility cameras 30, and the server device 100 according to the embodiment described above are implemented by, for example, a computer 1000 having a configuration as illustrated in FIG. 11. The server device 100 will be described as an example. FIG. 11 is a hardware configuration diagram illustrating an example of the computer 1000 that implements the functions of the server device 100. The computer 1000 includes a CPU 1100, a RAM 1200, a ROM 1300, a secondary storage device 1400, a communication interface 1500, and an input and output interface 1600. The components of the computer 1000 are connected by a bus 1050.

The CPU 1100 operates in accordance with a program stored in the ROM 1300 or the secondary storage device 1400 and controls each of the components. For example, the CPU 1100 loads a program stored in the ROM 1300 or the secondary storage device 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The secondary storage device 1400 is a computer-readable recording medium that non-transiently records a program to be executed by the CPU 1100, data used by such a program, and the like. Specifically, the secondary storage device 1400 is a recording medium that records a program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display, a speaker, or a printer via the input and output interface 1600. Furthermore, the input and output interface 1600 may function as a media interface that reads a program or the like recorded in a predetermined recording medium (medium). A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the server device 100 according to the embodiment, the CPU 1100 of the computer 1000 implements the function of the control unit 103 by executing a program loaded on the RAM 1200. Furthermore, the secondary storage device 1400 stores a program according to the present disclosure or data in the storage unit 102. Note that although the CPU 1100 reads the program data 1450 from the secondary storage device 1400 and executes the program data 1450, as another example, these programs may be acquired from another device via the external network 1550.

### 9. Conclusion

As described above, according to the embodiment of the present disclosure, the server device 100 (corresponding to an example of the “information processing device”) includes the control unit 103 capable of communicating with an XR terminal 10 (corresponding to an example of the “terminal device”) including the HMI unit 12 (corresponding to an example of the “presentation unit”) that presents XR content to a user U and the terminal camera 11a (corresponding to an example of the “first camera”) and a facility camera 30 (corresponding to an example of the “imaging device”) including the camera 31 (corresponding to an example of the “second camera”) disposed in the same space as the XR terminal 10. A control unit as described herein, such as the control unit 103, may be regarded as a controller or control circuitry. The presentation unit may be regarded or referred to herein as a presenter. The control unit 103 acquires user information including the attribute of the user U estimated by the facility camera 30 on the basis of a captured image by the camera 31 and locus information indicating the locus of the user U from facility cameras 30, associates the user information with the XR terminal 10 by collating the locus information of the user U by the facility cameras 30 with the locus information of the user U indicated by the XR terminal 10, and causes the XR terminal 10 to change the mode of the XR content to be presented by the XR terminal 10 to the HMI unit 12 depending on the user information. As a result, appropriate XR content depending on each user can be provided.

As will be appreciated by one skilled in the art, aspects of the present disclosure may be embodied as a system, method or computer program product. Accordingly, aspects of the present disclosure may take the form of an entirely hardware embodiment, an entirely software embodiment, including firmware, resident software, or micro-code, as examples, or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Although the embodiments of the present disclosure have been described above, the technical scope of the present disclosure is not limited to the above embodiments as they are, and various modifications can be made without departing from the gist of the present disclosure. In addition, components of different embodiments and modifications may be combined as appropriate.

Furthermore, the effects of the embodiments described herein are merely examples and are not limiting, and other effects may be achieved.

Note that the present technology can also have the following configurations.
(1)

An information processing device comprising:
a control unit capable of communicating with a terminal device comprising a presentation unit that presents XR content to a user and a first camera and an imaging device comprising a second camera disposed in a same space as the terminal device,
wherein the control unit
acquires, from the imaging device, user information including an attribute of the user estimated by the imaging device on a basis of a captured image by the second camera and locus information indicating a locus of the user,
associates the user information with the terminal device by collating the locus information of the user by the imaging device with locus information of the user indicated by the terminal device, and
causes the terminal device to change a mode of the XR content presented by the terminal device to the presentation unit depending on the user information.
(2)

The information processing device according to (1),
wherein the control unit causes the terminal device to change the mode of the XR content to be displayed on the presentation unit by the terminal device depending on the user information.
(3)

The information processing device according to (2),
wherein the imaging device estimates an external attribute of the user including a height on a basis of the captured image by the second camera, and
the control unit causes the terminal device to change a height at which the XR content is displayed depending on the height.
(4)

The information processing device according to (2) or (3),
wherein the imaging device estimates a demographic attribute of the user including age and gender on a basis of the captured image by the second camera, and
the control unit causes the terminal device to change content of the XR content to be displayed depending on the demographic attribute.
(5)

The information processing device according to (4),
wherein the imaging device estimates a psychographic attribute of the user including a lifestyle and a preference on a basis of the captured image by the second camera, and
the control unit causes the terminal device to change content of the XR content to be displayed depending on the psychographic attribute.
(6)

The information processing device according to (5),
wherein the control unit
displays a virtual door in the XR space in a case where the user arrives at a specific location in the XR space, and
causes the terminal device to change the content of the XR content to be displayed after the user passes through the door depending on the demographic attribute or the psychographic attribute.
(7)

The information processing device according to any one of (1) to (6),
wherein the control unit
acquires, from the terminal device, a feature point in a captured image by the first camera extracted by the terminal device, and
estimates user position information including a position and an orientation of the terminal device in the same space on a basis of the feature point and a three-dimensional (3D) map of the same space.
(8)

The information processing device according to (7),
wherein the control unit records a log of the user position information as the locus information of the user indicated by the terminal device.
(9)

The information processing device according to any one of (1) to (6), wherein the control unit
acquires, from the terminal device, global positioning system (GPS) position information measured by the terminal device, and
records a log of the GPS position information as the locus information of the user indicated by the terminal device.
(10)

The information processing device according to any one of (1) to (6),
wherein the control unit records a log of position information of the terminal device using one or more beacon terminals provided in the same space as the locus information of the user indicated by the terminal device.
(11)

An information processing device comprising: a control unit capable of communicating with a server device; a presentation unit that presents XR content to a user; and a first camera,
wherein the server device
is capable of communicating with an imaging device comprising a second camera disposed in a same space as the information processing device, and
acquires, from the imaging device, user information including an attribute of the user estimated by the imaging device on a basis of a captured image by the second camera and locus information indicating a locus of the user, and
the control unit
acquires the user information from the server device, the user information associated with the information processing device by the server device by collating the locus information of the user by the imaging device with locus information of the user indicated by the information processing device, and
changes a mode of the XR content presented to the presentation unit depending on the user information.
(12)

An information processing method executed by an information processing device capable of communicating with a terminal device comprising a presentation unit that presents XR content to a user and a first camera and an imaging device comprising a second camera disposed in a same space as the terminal device, the method comprising the steps of:
acquiring, from the imaging device, user information including an attribute of the user estimated by the imaging device on a basis of a captured image by the second camera and locus information indicating a locus of the user,
associating the user information with the terminal device by collating the locus information of the user by the imaging device with locus information of the user indicated by the terminal device, and
causing the terminal device to change a mode of the XR content presented by the terminal device to the presentation unit depending on the user information.
(13)

A program for causing a computer, which is an information processing device capable of communicating with a terminal device including a presentation unit that presents XR content to a user and a first camera and an imaging device including a second camera disposed in a same space as the terminal device, to execute the steps of:
acquiring, from the imaging device, user information including an attribute of the user estimated by the imaging device on the basis of a captured image by the second camera and locus information indicating a locus of the user;
associating the user information with the terminal device by collating the locus information of the user by the imaging device with locus information of the user indicated by the terminal device; and
causing the terminal device to change a mode of the XR content presented by the terminal device to the presentation unit depending on the user information.
(14)

A computer-readable recording medium storing a program for causing a computer, which is an information processing device capable of communicating with a terminal device including a presentation unit that presents XR content to a user and a first camera and an imaging device including a second camera disposed in a same space as the terminal device, to execute the steps of:
acquiring, from the imaging device, user information including an attribute of the user estimated by the imaging device on the basis of a captured image by the second camera and locus information indicating a locus of the user;
associating the user information with the terminal device by collating the locus information of the user by the imaging device with locus information of the user indicated by the terminal device; and
causing the terminal device to change a mode of the XR content presented by the terminal device to the presentation unit depending on the user information.
(1A)

An information processing device comprising:
control circuitry configured to communicate with each of a terminal device that has a presenter to present virtual content to a user and a first camera, and an imaging device having a second camera disposed in a same space as the terminal device,
wherein the control circuity is configured to
acquire, from the imaging device, user information including an attribute of the user estimated by the imaging device based on a captured image captured by the second camera, and locus information indicating a locus of the user,
associate the user information with the terminal device by collating the locus information of the user indicated by the imaging device with locus information of the user indicated by the terminal device,
output signaling to cause the terminal device to set a mode of the virtual content presented by the terminal device to the presenter depending on the user information, and
output control signaling to display the virtual content on the presenter of the terminal device.
(2A)

The information processing device according to (1A),
wherein the control circuitry outputs the signaling to cause the terminal device to change the mode of the virtual content to be displayed on the presenter by the terminal device depending on the user information.
(3A)

The information processing device according to (1A) or (2A),
wherein the imaging device estimates an external attribute of the user including a height based on the captured image by the second camera, and
the control circuitry is configured to output signaling to cause the terminal device to change a height at which the virtual content is displayed on the presenter by the terminal device depending on the height.
(4A)

The information processing device according to any one of (1A) to (3A),
wherein the imaging device estimates a demographic attribute of the user including age and gender based on the captured image captured by the second camera, and
the control circuitry is configured to output signaling to cause the terminal device to change content of the virtual content to be displayed on the presenter by the terminal device depending on the demographic attribute.
(5A)

The information processing device according to any one of (1A) to (4A),
wherein the imaging device estimates a psychographic attribute of the user including a lifestyle and a preference based on the captured image by the second camera, and
the control circuitry is configured to output signaling to cause the terminal device to change content of the virtual content to be displayed depending on the psychographic attribute.
(6A)

The information processing device according to any one of (1A) to (5A),
wherein the control circuitry is configured to
output signaling to cause display of a virtual door in an XR space in a case where the user arrives at a specific location in the XR space, and
output signaling to cause the terminal device to change the content of the virtual content to be displayed after the user passes through the virtual door depending on the demographic attribute and/or the psychographic attribute.
(7A)

The information processing device according to any one of (1A) to (6A),
wherein the control circuitry is configured to
acquire, from the terminal device, a feature point in a captured image by the first camera extracted by the terminal device, and
estimate user position information including a position and an orientation of the terminal device in the same space based on the feature point and a three-dimensional (3D) map of the same space.
(8A)

The information processing device according to any one of (1A) to (7A),
wherein the control circuitry is configured to record a log of the user position information as the locus information of the user indicated by the terminal device.
(9A)

The information processing device according to any one of (1A) to (8A), wherein the control circuitry is configured to
acquire, from the terminal device, global positioning system (GPS) position information measured by the terminal device, and
record a log of the GPS position information as the locus information of the user indicated by the terminal device.
(10A)

The information processing device according to any one of (1A) to (9A), wherein the control circuitry is configured to record a log of position information of the terminal device using one or more beacon terminals provided in the same space as the locus information of the user indicated by the terminal device.
(11A)

The information processing device according to any one of (1A) to (10A),
wherein the presenter includes an output interface having a display,
the virtual content includes extended reality (XR) content, the XR content including content that presents, to an XR space, one or more virtual objects, and
the mode of the XR content is one or more of a display mode, an audio mode, and/or a tactile mode.
(12A)

An information processing device comprising:
control circuitry configured to communicate with a server;
a presenter configured to present virtual content to a user; and
a first camera,
wherein the server is configured to
   communicate with an imager that has a second camera disposed in a same space as the information processing device, and
   acquire, from the imaging device, user information including an attribute of the user estimated by the imager based on a captured image by the second camera and locus information indicating a locus of the user, and
the control circuitry of the information processing device is configured to
acquire the user information from the server, the user information associated with the information processing device by the server by collating the locus information of the user by the imager with locus information of the user indicated by the information processing device, and
set a mode of the virtual content presented to the presentation presenter depending on the user information.
(13A)

The information processing device according to (12A), wherein the presenter includes an output interface having a display.
(14A)

The information processing device according to (12A) or (13A), wherein the virtual content includes extended reality (XR) content, the XR content including content that presents, to an XR space, one or more virtual objects.
(15A)

The information processing device according to any one of (12A) to (14A), wherein the mode of the XR content is one or more of a display mode, an audio mode, and/or a tactile mode.
(16A)

The information processing device according to any one of (12A) to (15A), wherein the control circuitry of the information processing device, when setting the mode of the virtual content, changes the mode of presentation of the virtual content depending upon the user information.
(17A)

The information processing device according to any one of (12A) to (16A), wherein the changing of the mode of the presentation of the virtual content includes changing one or more visual characteristics of the presentation of the virtual content.
(18A)

An information processing method involving an information processing device capable of communicating with a terminal device that has a presenter to present virtual content to a user and a first camera, and an imaging device having a second camera disposed in a same space as the terminal device, the method comprising:
acquiring, from the imaging device, user information including an attribute of the user estimated by the imaging device based on a captured image captured by the second camera and locus information indicating a locus of the user,
associating the user information with the terminal device by collating the locus information of the user indicated by the imaging device with locus information of the user indicated by the terminal device, and
outputting signaling to cause the terminal device to change a mode of the virtual content presented by the terminal device to the presenter depending on the user information.

### REFERENCE SIGNS LIST

1, 1A Information processing system
3 XR facility
10 XR terminal
11 Sensor unit
11a Terminal camera
11b Inertial sensor
12 HMI unit
13 Communication unit
14 Storage unit
15 Control unit
30 Facility camera
31 Camera
33 Communication unit
34 Storage unit
100 Server device
101 Communication unit
102 Storage unit
103 Control unit
U User

1. An information processing device comprising:
control circuitry configured to communicate with each of a terminal device that has a presenter to present virtual content to a user and a first camera, and an imaging device having a second camera in a same space as the terminal device,
wherein the control circuity is configured to
acquire, from the imaging device, user information including an attribute of the user estimated by the imaging device based on a captured image captured by the second camera, and locus information indicating movement of the user over time,
associate the user information with the terminal device by collating the locus information of the user indicated by the imaging device with locus information of the user indicated by the terminal device,
output signaling to cause the terminal device to set a mode of the virtual content presented by the terminal device to the presenter depending on the user information, and
output control signaling to display the virtual content on the presenter of the terminal device.

2. The information processing device according to claim 1,
wherein the control circuitry outputs the signaling to cause the terminal device to set the mode of the virtual content to be displayed on the presenter by the terminal device depending on the user information.

3. The information processing device according to claim 2,
wherein the imaging device estimates an external attribute of the user including a height based on the captured image by the second camera, and
the control circuitry is configured to output signaling to cause the terminal device to change a height at which the virtual content is displayed on the presenter by the terminal device depending on the height.

4. The information processing device according to claim 2,
wherein the imaging device estimates a demographic attribute of the user including age and gender based on the captured image captured by the second camera, and
the control circuitry is configured to output signaling to cause the terminal device to change content of the virtual content to be displayed on the presenter by the terminal device depending on the demographic attribute.

5. The information processing device according to claim 4,
wherein the imaging device estimates a psychographic attribute of the user including a lifestyle and a preference based on the captured image by the second camera, and
the control circuitry is configured to output signaling to cause the terminal device to change content of the virtual content to be displayed depending on the psychographic attribute.

6. The information processing device according to claim 5,
wherein the control circuitry is configured to
output signaling to cause display of a virtual door in an XR space in a case where the user arrives at a specific location in the XR space, and
output signaling to cause the terminal device to change the content of the virtual content to be displayed after the user passes through the virtual door depending on the demographic attribute and/or the psychographic attribute.

7. The information processing device according to claim 1,
wherein the control circuitry is configured to
acquire, from the terminal device, a feature point in a captured image by the first camera extracted by the terminal device, and
estimate user position information including a position and an orientation of the terminal device in the same space based on the feature point and a three-dimensional (3D) map of the same space.

8. The information processing device according to claim 7,
wherein the control circuitry is configured to record a log of the user position information as the locus information of the user indicated by the terminal device.

9. The information processing device according to claim 1, wherein the control circuitry is configured to
acquire, from the terminal device, global positioning system (GPS) position information measured by the terminal device, and
record a log of the GPS position information as the locus information of the user indicated by the terminal device.

10. The information processing device according to claim 1,
wherein the control circuitry is configured to record a log of position information of the terminal device using one or more beacon terminals provided in the same space as the locus information of the user indicated by the terminal device.

11. The information processing device according to claim 1,
wherein the presenter includes an output interface having a display,
the virtual content includes extended reality (XR) content, the XR content including content that presents, to an XR space, one or more virtual objects, and
the mode of the XR content is one or more of a display mode, an audio mode, and/or a tactile mode.

12. An information processing device comprising:
control circuitry configured to communicate with a server;
a presenter configured to present virtual content to a user; and
a first camera,
wherein the server is configured to
communicate with an imager that has a second camera disposed in a same space as the information processing device, and
acquire, from the imaging device, user information including an attribute of the user estimated by the imager based on a captured image by the second camera and locus information indicating movement of the user over time, and
the control circuitry of the information processing device is configured to
acquire the user information from the server, the user information associated with the information processing device by the server by collating the locus information of the user by the imager with locus information of the user indicated by the information processing device, and
set a mode of the virtual content presented to the presentation presenter depending on the user information.

13. The information processing device according to claim 12, wherein the presenter includes an output interface having a display.

14. The information processing device according to claim 12, wherein the virtual content includes extended reality (XR) content, the XR content including content that presents, to an XR space, one or more virtual objects.

15. The information processing device according to claim 12, wherein the mode of the XR content is one or more of a display mode, an audio mode, and/or a tactile mode.

16. The information processing device according to claim 12, wherein the control circuitry of the information processing device, when setting the mode of the virtual content, changes the mode of presentation of the virtual content depending upon the user information.

17. The information processing device according to claim 16, wherein the changing of the mode of the presentation of the virtual content includes changing one or more visual characteristics of the presentation of the virtual content.

18. An information processing method involving an information processing device capable of communicating with a terminal device that has a presenter to present virtual content to a user and a first camera, and an imaging device having a second camera disposed in a same space as the terminal device, the method comprising:
acquiring, from the imaging device, user information including an attribute of the user estimated by the imaging device based on a captured image captured by the second camera and locus information indicating movement of the user over time,
associating the user information with the terminal device by collating the locus information of the user indicated by the imaging device with locus information of the user indicated by the terminal device, and
outputting signaling to cause the terminal device to change a mode of the virtual content presented by the terminal device to the presenter depending on the user information.
